(19) United States
(12) Patent Application Publication
(10) Pub. No.: US 2018/0026383 A1
(43) Pub. Date: Jan. 25, 2018

(54) Arrangement with a Connector for at Least One Electrical Cable

(71) Applicant: NEXANS, Paris (FR)

(72) Inventors: Gert STAUCH, Hof (DE); Peter GROTSCH, Rehau (DE)

(21) Appl. No.: 15/213,868

(22) Filed: Jul. 19, 2016

(51) Int. Cl. H01R 11/26; H01R 4/56; H01B 1/02

(52) U.S. Cl. CPC H01R 11/26; H01B 1/023; H01R 4/56

(57) ABSTRACT

An arrangement with a connector for at least one electrical cable is indicated, that is surrounded by a cover, having an electrical conductor, which has a plurality of individual wires. The connector has a pipe shaped clamping body composed of metal to receive the conductors of the cables, in the walls of which at least one position with two threads is provided, mounted with interacting throughholes, their axis V-formed extended at an angle, lying between 100° and 180 °. In the mounted position the clamping screws are attached tightly in the throughholes of the conductor, which act in the same area of the conductor. In the mounted position, the clamping screws screwed in the two throughholes are rounded on their points each with a radius lying between 0.15×D and 0.5×D, with the diameter D of the threaded part of the clamping screws.

### RELATED APPLICATION

This application claims the benefit of priority from European Patent Application No. 15 306 210.4, filed on Jul. 24, 2015, the entirety of which is incorporated by reference.

### BACKGROUND

### Field of the Invention

The invention relates to an arrangement with a connector for at least one electrical cable, that is surrounded by a cover, having an electrical conductor, which has a plurality of individual wires, by which the connector has a pope shaped clamping body composed of metal to receive the conductors of the cables, in the walls of which at least one position with two threads is provided, mounted with interacting throughholes, the axis V-formed extended at an angle, lying between 100° and 180°, in which in the mounted position the conductor is securely fastened with the clamping screws.

### DESCRIPTION OF RELATED ART

Such an arrangement is described, for example, in US 2004/015370 A1.

The words “plurality of individual wires” means in the sense of the invention, that the conductor has at least 100 stranded together or twisted individual conductors. A previously described arrangement in different embodiments has been known for years and is available on the market. The connector can be used for the connection of two electrical cables performing as a pipe. They can be used to attach only electrical cables, also be locked on the front side and there have an outer facing protruding contact element. Known arrangements differ substantially through the construction and the arrangement of the clamping screws, which in most cases, perform as shear screws. The contact pressure, with which a clamping screw in the mounted position pushes against an electrical conductor, should be as strong as possible and be held longer, so that a stable electrical connection of the electrical conductor from cables, especially from energy cables ensures that the total required service life can be guaranteed.

In addition, in stranded conductors the individual wires themselves rub against each other because of the pull of the clamping screw, causing compression. This leads to that in the inner space of the conductor a lesser pressure is generated as on the surface of the same. The connection of cross section or segmented conductors, so called “Milliken conductors” can lead to problems. When the contact of the individual wires in the inner space of the conductor is insufficient, it results in an above average heating at the connection point. With conductors composed of aluminum, the heating can lead to increased flowing of the materials and as a result after a short time lead to a decrease in the contact pressure. The electrical connection between the clamping screws and the conductor or between the conductors and the clamping body is then relatively quickly unusable.

From U.S. Pat. No. 6,338,658 B1 a clamping screw is known, which can be screwed in a threaded hole of a metal body. The metal body has a receiving space for receiving a stranded electrical conductor. The conductor can, in the mounted position, be secured by means of a clamping screw. The point of the clamping screw runs conically and, in fact, extended at an angle of approximately 30°. The cone is on its end dull rounded slightly with a small radius. The metal body is provided with two holes on the sides through which the pressed individual wires separated by the clamping screw can run around the conductor.

EP 2 148 392 A1 discloses an arrangement with a connector to secure two cables out of flexible electrical conductors. The connector has a metal clamping body finished as a pipe piece, which has at least two threaded throughholes to receive the clamping screws. In a clamping screw on the front side, which is intended for the system on each electrical conductor, is mounted a sphere in a recess. The sphere is in the recess through its movable secure gap separated from the walls in all directions rotatably arranged and in the work position protrudes over the front side of the clamping screw. Damage to the surface of the conductor is impossible because of the use of these special clamping screws.

In the previously mentioned US 2004/0152370 A1 is a clamping body described with threaded holes, in which to screw in place an electrical conductor clamping screws can be used. On a position on the clamping body two clamping screws are so arranged that their axes extend at an angle to each other. The clamping screws are transversally offset relative to each other and they can also be offset relative to each other in the axial direction. With this arrangement the clamping screws can achieve a better electrical and mechanical contact.

### OBJECTS AND SUMMARY

The invention is based on the object that the previously described arrangement is so designed that also flexible electrical conductors with a plurality of individual wires can be securely and completely contacted.

According to the invention this object is met in
that in the mounted position the two clamping screws screwed in the throughholes on the same side of the clamping body located in the conductor, act on the same in the same area and
that each of the two clamping screws on their points is rounded with a radius, which lies between 0.15×D and 0.5×D, with the diameter D of the threaded part of the clamping screws.

With this arrangement, the two clamping screws, which are arranged in the two throughholes of the connector, their axes V-formed running toward each other, on the same side in the clamping body located in the conductor, act on the same area of the same. They push with sufficient force implementing rotation in the conductor, pushing thereby the individual wires compactly together and also against the walls of the clamping body on the opposite side of the throughholes. As a result, it is sufficient for the required electrical contact of all the individual wires of the conductor, if the two described clamping screws are screwed sufficiently tight in the clamping body. On the two oppositely lying clamping screw sides of the clamping body no additional clamping screws are required. In addition, the individual wires of the conductors are only pushed together going through the two clamping screws, without being damaged or destroyed. This is ensured by the rounding of the point of the clamping screws with a radius from 0.28×D, where D is the diameter of the threaded part of the clamping screw.

Especially advantageous, the arrangement for a flexible electrical conductor would use aluminum or aluminum alloys for their individual conductors. One such conductor has, for example, by a cross section from 400 mm², approximately 1400 individual wires. Because of the rounded points on the clamping screws this plurality of individual wires is sufficiently compressed enough for an efficient electrical connection. One of the aluminum or aluminum alloy wires surrounding thin oxide layer is broken off by the clamping screws with plastic deformation, so that there is an efficient electrical passage of the conductor throughout its cross section. The oxide layer of the individual wire can have a maximum thickness of 10 mm.

### BRIEF DESCRIPTION OF THE DRAWINGS

Embodiments of the present subject matter are illustrated in the drawings.

In the drawings:

FIGS. 1 and 2 show purely schematically two different clamping bodies for an arrangement according to the invention.

FIGS. 3 to 5 show a sectional view through a usable connector in the arrangement according to the invention.

### DETAILED DESCRIPTION

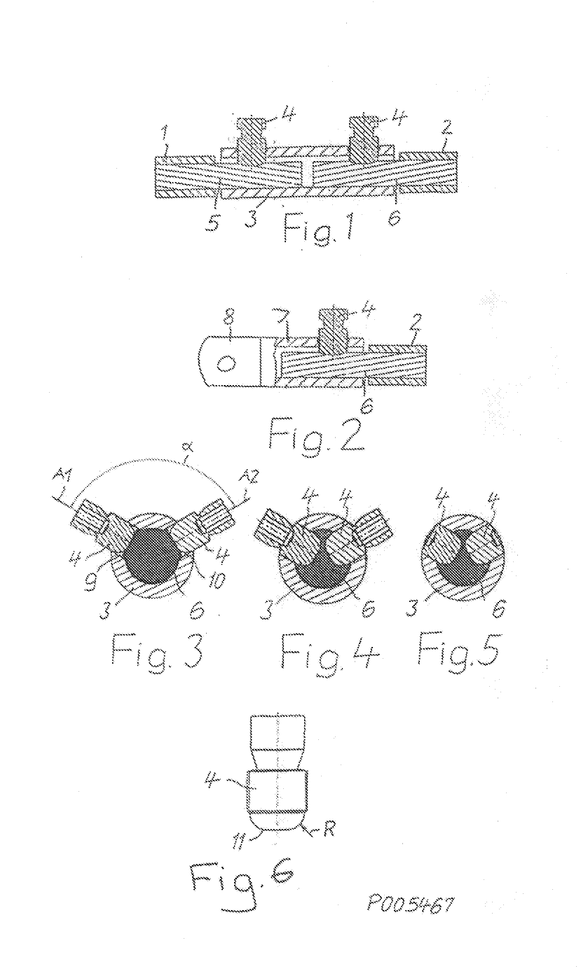

FIGS. 1 and 2 generally illustrate two different connectors for two electrical cables on one side and for one electrical cable on the other side. In this sense, one connector for two electrical cables 1 and 2 where there may be energy cables to act on is schematically illustrated. There is a clamping body 3 constructed as a pipe composed of tinned aluminum alloy, for example. The clamping body 3 has two threaded holes in which in each is arranged a clamping screw 4 provided with an external thread. Out of two different sides the electrical conductors 5 and 6 of the two electrical cables 1 and 2 protrude into the clamping body 3. In the mounted position, the conductors 5 and 6 are secured in the clamping body 3 through the clamping screw 4 and thereby electrically conductively connected to each other. They are in the preferred embodiment constructed as multi wired conductors and are composed, for example, of aluminum or copper.

In the embodiment of the connectors according to FIG. 2, is shown instead of the pipes 3, a pipe shaped clamping body 7 which is locked on a front side. An electrical contact element sticks out from this front side, which serves to attach an electrical device. Accordingly, only the conductor 6 of the cable 2 is introduced in the clamping body 7 and secured through the clamping screw.

Only the clamping body 3 is illustrated in cross section in FIGS. 3 to 5. But it could also be the clamping body 7. In the clamping body 3 the electrical conductor 6 is arranged and secured through the two clamping screws.

The conductor 6 is advantageously composed of a plurality or individual wires of aluminum or an aluminum alloy, that are stranded with each other or generally speaking are meshed. The individual wires can, for example, also be composed of copper or another good electrically conductive material. It should have as a high count, at least 300 individual wires. In the previously described embodiment the conductor 6 has approximately 1400 individual wires and an electrically affective cross section of approximately 400 mm². This embodiment of the conductor 6 also basically applies to the conductor 5.

The two clamping screws 4 provided with an external thread are screwed into the throughholes 9 and 10 of the clamping body 3, which is equipped with threading. The axes A1 and A2 of the two throughholes 9 and 10 run V-formed toward each other extended at an angle α, which can lie between 100° and 180°. The angle α advantageously lies at 120°.

The two clamping screws 4 are illustrated in the drawing as shear screws. According to FIG. 6, they have a rounded point 11 with which it lies against conductor 6 in the mounted position. The point 6 of the clamping screw 4 can be rounded with a radius R, which can lie between 0.15×D and 0.5×D. As a result, D is the diameter of the threaded part of the clamping screws 4. The radius R with the point 11 of the clamping screws 4 is rounded and lies advantageously at 0.28×D.

For the final installation of the conductor 6 in the clamping body 3 the clamping screws 4 are rotated on their axes. As a result, they push into the conductor 6 and push the individual wires of the same together and, because of their inclined path relative to each other, into the same area of the conductor 6. At the same time, the individual wires are pushed together and because of the rounded point 11, the clamping screws are not damaged. Only the oxide layer surrounding the individual wires will be broken off. The final position of the clamping screws 4 is illustrated in FIGS. 4 and 5 where, according to FIG. 5, the top part of the clamping screws 4 is sheared off.

1. A connector for connecting one or more electrical cables, the cables being surrounded by a cover and having electrical conductors that are formed from a plurality of individual wires, said connector comprising:
a pipe shaped clamping body made of metal for receiving said electrical conductors of the cables,
wherein walls of said clamping body, at at least one position along the length of the clamping body, have two throughholes with threads, said throughholes having longitudinal central axes that extend V-shaped through said walls at an angle relative to one another, the angle lying between 100° and 180°, wherein when said conductor is in a mounted position, two clamping screws are arranged in the throughholes to securely fasten the conductor,
wherein when said conductor is in the mounted position, the two clamping screws screwed in the throughholes bear upon a same side of the conductor located in the clamping body at a same longitudinal position along a long axis of the conductor and
wherein both of the two clamping screws, on a front peak that contacts the conductor, are rounded, with a radius that lies between 0.15×D and 0.5×D, D being the diameter of a threaded part of the two clamping screws.

2. Connector according to claim 1, wherein the angle enclosed by the axes of the two throughholes is 120°.

3. Connector according to claim 1, wherein the radius of the rounding of the peak for the two clamping screws is 0.28×D.

4. Connector according to claim 1, wherein the clamping body is constructed as the pipe to connect two electrical cables.

5. Connector according to claim 1, wherein the clamping body is locked on one front side and has on the one front side an electrical contact element protruding outwards.

6. Connector according to claim 1, wherein said connector is configured to connect the at least one electrical cable with the plurality of individual wires composed of aluminum or aluminum alloy.
